(19) United States
(12) Patent Application Publication
(10) Pub. No.: US 2015/0120496 A1
(43) Pub. Date: Apr. 30, 2015

(54) Shopping System

(71) Applicant: Stuart Watson, Keswick (GB)

(72) Inventor: Stuart Watson, Keswick (GB)

(21) Appl. No.: 14/523,629

(22) Filed: Oct. 24, 2014

Related U.S. Application Data
(60) Provisional application No. 61/895,920, filed on Oct. 25, 2013.

(51) Int. Cl. G06Q 30/06; G06T 19/20; G06T 19/00

(52) U.S. Cl. CPC G06Q 30/0643; G06Q 30/0633; G06T 19/006; G06T 19/20; G06T 2219/2016; G06T 2210/16; G09G 2340/12
USPC 705/26.8; 705/27.2

(57) ABSTRACT

A shopping system allows a user to purchase an article of clothing, such as footwear or other wearable item, where the shopping system can employ devices, methods and non-transitory computer-readable medium storing executable computer program code to provide a virtual mirror, such as can be used with on-line shopping sites to enable a user to virtually try on clothes, etc., before committing to buy.

### CROSS REFERENCE TO RELATED APPLICATIONS

This application is a non-provisional of and claims priority to U.S. Provisional Patent Application No. 61/895,920, filed on Oct. 25, 2013, the entire contents of which are hereby incorporated by reference.

### BACKGROUND

1. Field of the Art

Embodiments of the invention relate to a computer system for providing a virtual mirror. In particular, but not exclusively, embodiments of the invention relate to a computer system for providing a virtual mirror for remote, or home, Internet shopping.

2. Description of the Related Art

The advent of the Internet has led to a significant increase in shopping via websites provided by retailers. However, when Internet shopping, it is not possible to try on clothes to see how they look before making a purchase.

### SUMMARY

According to a first aspect of the invention there is provided a method of allowing a user to purchase an article of clothing, comprising at least one of the following:

i) scanning a location of at least a portion of the user to generate a 3D model of that portion of the user;

ii) taking one or more images of the user;

iii) allowing a user to select a model article of clothing from one or more such models stored in a machine readable memory;

iv) manipulating the model of the selected article of clothing to map the selected article on the 3D model of that portion of the user;

v) modifying the, or each, image of the user to show the portion of the user having the model of the selected article mapped thereonto;

vi) causing a display to display the modified image; and

vii) allowing a user to add the selected article to a shopping cart.

According to a second aspect of the invention there is provided a system allowing a user to purchase an article of clothing, the system comprising, a processing circuit having connected thereto at least one of the following:

a camera arranged to take one or more images of a user;

a scanner arranged to determine the location of at least a portion of the user and generate a 3D model of that portion of the user;

a display arranged to display data supplied by the processing circuit; and

input mechanism arranged to allow a user to make an input to the processing circuit;

wherein the processing circuit has access to a memory having contained therein one or more models of articles of clothing and wherein the processing circuit is arranged to:
i) receive the 3D model of the portion of the user from the scanner;
ii) allow a user to select a model of an article of clothing from the memory by making an input to the input mechanism;
iii) manipulate the model of the article to map that article on to the 3D model of the portion of the user;
iv) modify the, or each, image of the user to show the portion of the user having the model of the selected article mapped thereonto;
v) to cause the display to display the modified image; and
vi) allow a user to add the selected article to a shopping cart by making a further input to the input mechanism.

According to a third aspect of the invention there is provided a non-transitory computer-readable medium storing executable computer program code allowing a user to purchase an article of clothing, the program code executable to perform steps comprising at least one of the following:

i) scanning a location of at least a portion of the user to generate a 3D model of that portion of the user;

ii) taking one or more images of the user;

iii) allowing a user to select a model article of clothing from one or more such models stored in a machine readable memory;

iv) manipulating the model of the selected article of clothing to map the selected article on the 3D model of that portion of the user;

v) modifying the, or each, image of the user to show the portion of the user having the model of the selected article mapped thereonto;

vi) causing a display to display the modified image; and

vii) allowing a user to add the selected article to a shopping cart.

The skilled person will appreciate that a feature of any one aspect of the invention may be applied, mutatis mutandis, to any other aspect of the invention.

Further the skilled person will appreciate that elements of the aspects may be provided in software. However, the skilled also appreciate that any software element may be provided in firmware and/or within hardware, or vice versa.

The machine readable medium referred to in any of the above aspects of the invention may be any of the following: a CDROM; a DVD ROM/RAM (including −R/−RW or +R/+RW); a hard drive; a memory (including a USB drive; an SD card; a compact flash card or the like); a transmitted signal (including an Internet download, ftp file transfer of the like); a wire; etc.

### DESCRIPTION OF DRAWINGS

There now follows, by way of example only, a detailed description of embodiments of the invention with reference to the accompanying drawings of which:

FIG. 1 schematically shows a processing system arranged to perform an embodiment of the invention;

FIG. 2 schematically shows a system arranged to enable an Internet shopping method;

FIG. 3A shows a flow chart outlining an Internet shopping process;

FIG. 3B shows more detail of the “manipulate model of item” step shown in

FIG. 3A; and

FIG. 4 shows a representation of a system comprising two scanners in use.

### DETAILED DESCRIPTION

The following description provides a description of various embodiments and the skilled person will readily appreciate that a feature described in relation to a given embodiment may be applied, mutatis mutandis, to any of the other embodiments.

The following description describes various embodiments relating to purchasing an item of clothing, with the specific example of shoes. The skilled person will readily appreciate that the embodiments can relate to any item of clothing, apparel or accessory that can be worn by a user. For example, embodiments may be used with shoes, trousers, shirts, tops, skirts, dresses, shorts, hats, glasses/sunglasses, gloves, jewelry and wigs.

Other embodiments can also relate to other elements of a user's appearance that are not clothing, apparel or accessories, such as hair styles and colours or plastic surgery.

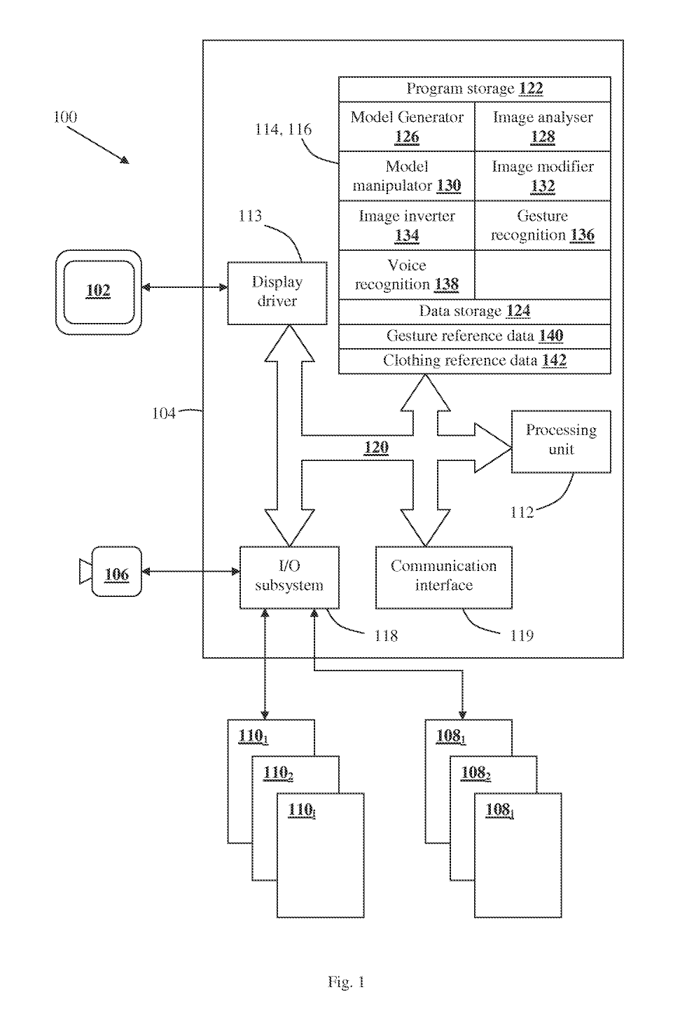

The computer system 100 of FIG. 1 exemplifies a computer system that may be used to provide the computer implemented methods described herein or as a computer system described herein. The computer system 100 comprises a display 102, processing circuitry 104, a camera 106, one or more scanners 108₁ . . . 108ⱼ and one or more input devices 110₁ . . . 110ᵢ. The processing circuitry 104 comprises a processing unit 112, a graphics system with display driver 113, a hard drive 114, a memory 116, an I/O subsystem 118, a communication interface 119 and system bus 120. The processing unit 112, graphics system 113, hard drive 114, memory 116, I/O subsystem 118 and communication interface 119 communicate with each other via the system bus 120, in a manner well known in the art.

Input devices 110 may be at least one of the following: a mouse, a keyboard or a touch screen provided with display 102 or separately from display 102, with inputs received by actuation of the device.

In one example, the input device 110 may comprise a further sensor provided in proximity to display 102 to detect user gestures as inputs. The data from the sensor is analysed to form a model in the manner described below and detected movements are compared against reference data to determine a user input. For example, detected gestures may include arm gestures corresponding to different inputs.

In another example, the input device may include a microphone and the processing circuitry 104 may be configured to process the detected sound waves to recognise voice commands as inputs.

The connection between the input device 110 and the I/O subsystem 118 may be wired, wireless or a combination of both. For example, where the input device 110 is a mouse, the mouse may be physically connected to the I/O subsystem by wire (and optionally ports and plugs) or the mouse may be a wireless mouse in communication with a wireless receiver that is connected to the input/output subsystem.

It will be appreciated that any single method or combination of the described user inputs may be used. The user inputs may also be used for general browsing of a retailer's website 206 and browsing of the Internet.

Similarly, the connections between the scanner 108 and camera 106 and the I/O system 118 and the display 102 and the display driver 113 may be wired, wireless or a combination of the two.

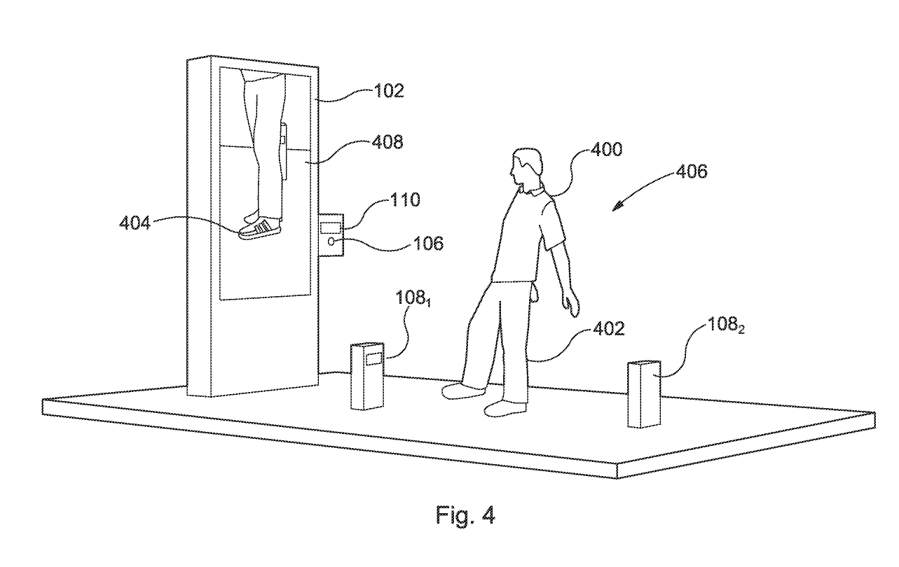

The display 102 can comprise any form of suitable display arranged to display images generated by the display driver 113. For example, the display may comprise a liquid crystal display, an LED display or a plasma display. The display may be a television or computer monitor. As shown in the example in FIG. 4, the display 102 may be arranged in a portrait orientation thereby such embodiments providing a more typical mirror configuration.

The camera 106 may comprise any suitable form of image detector that can detect visible light and provide an image for analysis. For example, the camera may be a high-definition camera. In some embodiments, the camera is a Canon Legria HF R36 (PAL for UK market). In another embodiment the camera may be a Canon Vixia HF R21 (NTSC suitable for International Market).

The graphics system 113 can comprise a dedicated graphics processor arranged to perform some of the processing of the data that it is desired to display on the display 102. Such graphics systems 113 are well known and increase the performance of the computer system by removing some of the processing required to generate a display from the processing unit 112. In some embodiments, the graphics system may be provided by BlackMagic Intensity Pro PCI Express video capture card.

It will be appreciated that although reference is made to a memory 116 it is possible that the memory 116 can be provided by a variety of devices. For example, the memory may be provided by a cache memory, a RAM memory, a local mass storage device such as the hard disk 114, any of these connected to the processing circuitry 104 over a network connection. However, the processing unit 112 can access the memory 116 via the system bus 120 and, if necessary, communications interface 119, to access program code to instruct it what steps to perform and also to access data to be processed. The processing unit 112 is arranged to process the data as outlined by the program code.

The program code may be delivered to memory 116 in any suitable manner. For example, the program code may be installed on the device from a CDROM; a DVD ROM/RAM (including −R/−RW or +R/+RW); a separate hard drive; a memory (including a USB drive; an SD card; a compact flash card or the like); a transmitted signal (including an Internet download, ftp file transfer of the like); a wire; etc.

In some embodiments it is entirely possible that a number of computer systems 100, processing circuits 104 and/or processing units 112 may be connected in parallel, and/or distributed across a network, in order to provide the method and/or computers systems described herein.

In some embodiments, the computer system 100 may be comprised in a computer or computer gaming system, and/or an accessory for such a system. For example, the processing circuitry 104 may be provided by a computer whilst the display 102, camera 106, scanners 108 and input device 110 are peripheral accessories connected to the computer. In one example, the computer system 100 may be comprised in an XBOX™ gaming system with the scanner 108 and camera 106 provided in an XBOX™ KINECT™ accessory and the display 102 provided by a television.

A schematic diagram of the memory 114,116 of the computer system is shown in FIG. 1. It can be seen that the memory comprises a program storage portion 122 dedicated to program storage and a data storage portion 124 dedicated to holding data.

In the embodiments being described, the program storage portion 122 comprises at least some of the following: model generator 126; image analyser 128; model manipulator 130; image modifier 132; image inverter 134; gesture recognition 136; and voice recognition 138. Further, the data storage 124 may comprise at least some of the following: gesture reference data 140; and clothing reference data 142, as described below. It will become apparent from the following that some of the processing circuits described may comprise only some of the elements shown in relation to FIG. 1.

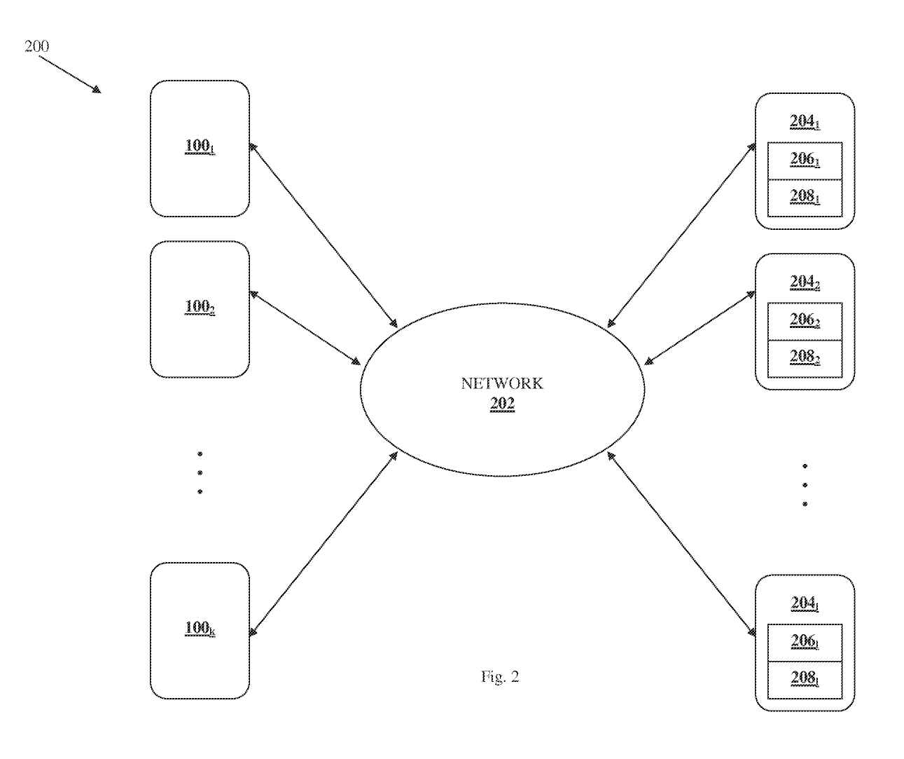

Turning to FIG. 2, system 200 comprises one or more computer systems 100₁ . . . 100ₖ operating as user terminals and one or more retailers 204₁ . . . 204_{I} operating retail websites 206₁ . . . 206_{I} with memory 208₁ . . . 208_{I} storing information about items sold through the website 206.

The user terminals 100 and retailers 204 are in communication with network 202 such that users of the user terminals 100 may view the websites 206 and may purchase items. The network 202 may comprise a single network local or wide area network or a plurality of such networks interconnected. In one example, the network 202 may comprise the Internet, and at least some of the user terminals 100 and/or at least some of the retailers 204 may connect to the Internet through local or wide area networks. Typically embodiments will work with the World Wide Web (WWW) and access the WWW via the Internet or other network.

Memory 208 can be provided by a variety of devices. For example, the memory 208 may be provided by a cache memory, a RAM memory, a local mass storage device, any of these connected to the website 206 and user terminal 100 over the network 202. User terminal 100 can access the memory 208 via the communication interface 119. Memory 208 can be located on a remote server accessible via network 202.

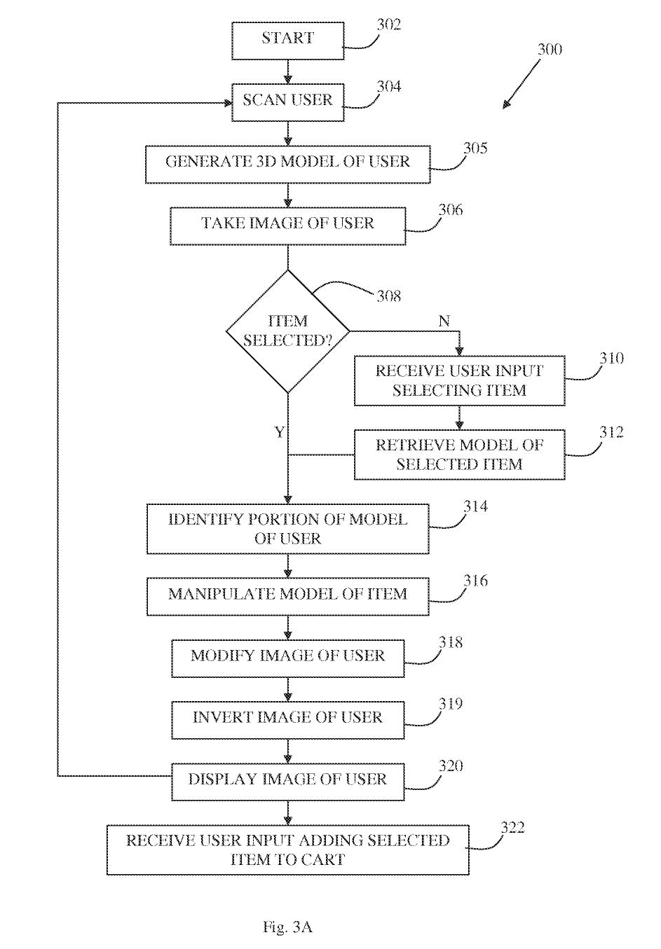

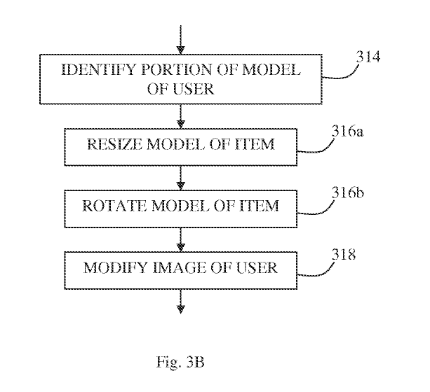

A process 300 for purchasing items from the websites 206 of retailers 204, using the computer system 100 of FIG. 1 and the system 200 of FIG. 2 is exemplified in FIGS. 3A and 3B and will be explained with reference to FIGS. 1, 2 and 4.

In the embodiment being described, the process 300 is started, at step 302, when a user 400 of terminal 100 is viewing a website 206 of a retailer 204. The process 300 may be started by a user input at terminal 100, for example, by the user 400 selecting a model item of clothing 404 or selecting to use a virtual mirror. Any suitable user input may be used (see above). Alternatively, the process may be started automatically whilst a user 400 is viewing a website 206 of a retailer 204.

At step 304, a scan is taken of the scene to be scanned 406, including the user 400 of terminal 100, using a first scanner 108₁. The first scanner 108₁ is arranged in proximity to the display 102, with the user 400 facing the display 102 and the scanner 108₁ at the same time. In the example shown in FIG. 4, the first scanner 108₁ is arranged between display 102 and user 400.

At step 305, model generator 126 takes as an input scan data from first scanner 108₁ and generates 305 a three dimensional model of the user 400. In embodiments, using a KINECT™ scanner, then the model generator 126 is arranged to process that output to generate a model as is known to do with the KINECT™ scanner thereby separating the user from the background.

It will be appreciated that the first scanner 108₁ may scan the whole of the user 400 or only a portion 402 of the user and model generator 126 may generate a model of the whole user 400, or only a portion 402 of the user 400.

The scanner 108₁ can be any type of scanner that can provide sufficient data points to generate a three dimensional model. For example, the scanner may comprise an infrared emitter and a camera sensitive to infrared light. The emitter illuminates a scene 406 to be scanned. An image is then taken of the illuminated scene 406. The model generator 126 analyses the image and generates a point map of where the infrared light from the emitted by the source reflects off a surface in the scene 406.

It will be appreciated that because only a front view is required, only a single scanner 108₁ is necessary to generate the three dimensional model of the user. However, referring to FIG. 4, it will also be appreciated that in some embodiments, two scanners 108₁, 108₂ may also be used. In such embodiments, the scanners are positioned to take images of the scene 406 from different aspects. For example, as shown in FIG. 4, the scanners 108₁, 108₂ may be arranged to be spaced by 180 degrees around the user. At least one of the scanners 108₁, 108₂ must be positioned in the same manner as described in the single scanner embodiment. Images corresponding to the same instant can be processed simultaneously, concurrently, in parallel or in series by model generator 126 to produce the three dimensional model.

In embodiments with two scanners 108₁, 108₂ the scene 406 is normally shown on the display 102 from the point of view of first scanner 108₁, the second scanner being used to improve the accuracy model, especially when the user 400 is moving. However, it may be possible for the user to select to view the scene from behind, from the point of view of scanner 108₂.

It will further be appreciated that other embodiments, three or more scanners 108 may be used, with the scanners arranged to view the scene 406 to be scanned from different angles around the user. Such embodiments help improve the accuracy of the model and allow viewing from different angles.

In addition to generating a model of the user 305, an image of the user is captured by camera 106 at step 306. The image corresponds to the same instant as when the scan was taken. The model and image are arranged to capture the same scene 406 and are thus of the same size. Therefore the model directly corresponds to the image taken.

At step 308, the processing unit 112 checks to see if the user 400 has already selected an item of clothing 404 to view. If an item 404 has already been selected, the process 300 proceeds to step 314. However, if no item 404 has previously been selected, the process moves to step 310 where the system 100 enables the user to select an item of clothing 404 to be viewed. For example, as shown in FIG. 4, the user 400 may select a shoe (or pair of shoes). Any suitable user input may be used (see above).

After receiving a user input selecting an item 404, the processing unit retrieves a stored model of the selected item of clothing 404, at step 312. The model of the model item of clothing 404 may be stored in memory 208 associated with the website 206 of the retailer 204. Selecting the item of clothing 404 may trigger retrieval of the model automatically which may therefore be across the network 202 or may be stored locally and accessed via a reference or other look up mechanism. Thus, in the embodiment being described the model is retrieved from a remote computer (i.e., from a website).

In alternative, or additional, embodiments the model of the item of clothing 404 (or other wearable item) may be loaded into the memory by another mechanism; such as via any of the machine readable media described herein.

The model of the item of clothing 404 can be any suitable three-dimensional model of the item of clothing 404. For example, the model may be any CAD (Computer Aided Design) model of the item of clothing 404 and may comprise a set of points resulting from a three dimensional scan of an actual item of clothing 404, similar to the three dimensional model of the user 400. Alternatively, the model of the item of clothing may comprise a rendered model or a model generated from a plurality of photos taken of an actual item of clothing 404. In one example, fifty photos may be used, but it will be appreciated that more or less photos may be used.

The model of the item of clothing 404 may be held in any of the following file formats: OBJ (Wavefront OBJ format); VRML (Virtual Reality Modelling Language); FBX (Autodesk FBX file); or the like.

In some embodiments, the model of the item of clothing 404 has previously been generated and loaded into memory 208.

The model for the item of clothing 404 is in some embodiments, including the embodiment being described, associated with metadata. This metadata will describe the type of clothing the model represents, for example, shoe. This metadata may be stored with the model and generated at the same time as the model or when the model is uploaded into the memory. Alternatively, this metadata may be determined by comparing the model to known reference data 142 to identify the type of clothing.

At step 314 image analyser 128 analyses the three dimensional model of the user 400 or portion of the user 402 and, using the metadata associated with the model of the item of clothing, identifies the body part of the user 400 associated with the selected item of clothing 404. The size, location and orientation of body part is identified. For example, if the selected item of clothing is a shoe 404, the image analyser 128 identifies the portion of the model the represents the user's foot and identifies, for example, that the foot is held flat, side-on off the ground, with the toes facing left.

At 316, the model of the selected item of clothing 404 is manipulated. FIG. 3B shows the process for manipulating the model of the item 404. At 316a, the model of the item 404 is resized so that it corresponds to the size of the associated body part in the model and image (identified in step 314). At step 316b, various model manipulations are performed to the model such that the orientation of the model corresponds to the orientation of the corresponding body part identified in step 314. Typically, the model has at least some of the following performed: re-sizing; rotating; translation; having perspective applied to match that of the camera 106.

For example, referring to FIG. 4, if the model is initially shown as front on, the model will be rotated to match the user's foot.

In additional or alternative embodiments, the model of the item 404 may be fitted against the associated body part such that the relative size between the model of the item 404 and the body part is maintained. As such, a user may be able to try on difference sizes to see how a particular size of article looks.

The image taken in step 306 is then modified 318 so that the manipulated model of the item of clothing 404 is mapped directly onto the image, with the model manipulated model overlaying the body part identified in step 314. This creates an image that gives the impression of the user 400 wearing the selected item of clothing in the image

The modified image is then inverted 319 to create a mirror image of the scene. The inverted image 408 is then displayed 320 on display 102. In this way, the display 102 acts like a mirror. Other embodiments may not invert the image in this manner.

It will be appreciated that the displayed imaged 408 may show the whole of the user 404 or may only show a portion of the user 402 associated with the item of clothing 404 selected. For example, the processing unit 112 may select to only show a portion 402 related to the selected item of clothing 404, thus providing a zoom function.

The process may display a single image 408, as a still picture. Alternatively, the process may return to 304 and repeat the process. By repeating the process at a suitable rate, a moving image may be presented substantially replicating the effect of a mirror. For example, the process may be repeated at a rate of 50 to 60 times per second. It will be appreciated that in other embodiments different frame rates may be used.

The process includes step 322 in which the user is able to add the selected item to an electronic shopping cart for purchase once they have finished browsing website 206. Any suitable user input may be used to trigger this action (see above).

It will be appreciated that although the steps of the process 300 have been described in a particular order, it is also possible that the order of certain steps may be changed without effecting the operation of the system 100.

Thus, embodiments as described above may be used as a front end for a commercial shopping web-site. As such, embodiments may allow a user to select items from a web-site and virtually try-on that article and finally to add that article to the shopping cart of the web-site.

It will be appreciated that the method of any of the embodiments described herein may further comprise retrieving the model of the selected article of clothing from a remote machine readable memory accessible over a network connection, and optionally the remote machine readable memory is accessed via the Internet.

In additional or alternative embodiments, allowing a user to select an article of clothing may comprise:
determining if an article of clothing has already been selected; and
if an article has already been selected, proceeding to the next step; and

if an article has not already been selected,
enabling receipt of a user input selecting an article.

Alternatively or additionally, the method may allow the article of clothing to change any aspect of the appearance of the user. In additional or alternative embodiments, the method may enable the user to shop over the Internet, perhaps at home. However, the skilled person will appreciate that the system described in any of the above embodiments can be situated in any suitable location which might include any of the following examples: a library; a shop; a bus-stop, exhibition halls or the like. Embodiments may be provided as a transportable system for movement between locations.

It will be appreciated that any, some or all of the features listed below may be incorporated into any of the embodiments described herein.

The system of any embodiment may further comprise a remote machine readable memory storing the model of the article of clothing, the remote machine readable memory accessible over a network connection.

In additional or alternative embodiments, the remote machine readable memory is accessible over the Internet.

In additional or alternative embodiments, the first scanner is arranged to be positioned such that, in use, the user faces both the display and first scanner. Optionally, in such embodiments, the system further comprises a second scanner, the second scanner being arranged to take scans at substantially the same time as the first scanner. In embodiments comprising two or more scanners, the first and second scanners may be arranged to be positioned such that, in use, they are angularly spaced around the user.

The skilled person will understand that, in additional or alternative embodiments, the system further comprises a user input scanner, the user input scanner being arranged to scan the user and generate a user input 3D model, and the processing circuit being further arranged to analyse the user input model to determine a gesture made by the user; and compare the gesture made to reference data correlating known gestures to different user inputs.

In additional or alternative embodiments, the scanner may comprise an infrared emitter and an infrared camera, the processing circuit being arranged to analyse an image taken by the infrared camera to determine where a beam of the infrared emitter reflects from the user.

The skilled person will understand that the system may be a home shopping system that enables the user to shop at home, over the Internet and that the article of clothing may change any aspect of the appearance of the user.

What is claimed is:

1. A method of allowing a user to purchase an article of clothing, the method comprising:
i) obtaining a three dimensional (3D) model of at least a portion of the user, wherein the 3D model is generated from a scan of a location in which at least the portion of the user is located;
ii) taking one or more images of the user with a camera in proximity to the location;
iii) obtaining user selection of an article of clothing from more than one model of articles of clothing stored in a machine readable memory;
iv) manipulating the model of the selected article of clothing to map the selected article on the 3D model of the portion of the user, wherein the manipulating includes at least one of re-sizing, rotating, translation, or having perspective applied to match that of the camera;
v) modifying the, or each, image of the user to show the portion of the user having the model of the selected article mapped thereonto; and
vi) causing a display to display the modified image.

2. The method according to claim 1, comprising receiving user input to add the selected article of clothing to a shopping cart of a web-site, wherein the selected article of clothing comprises footwear.

3. The method according to claim 1, comprising:
analyzing the 3D model of at least the portion of the user using metadata associated with the model of the selected article of clothing to identify a body part of the user in the 3D model that is associated with the selected article of clothing; and
determining size, location and orientation of the identified body part of the user.

4. The method according to claim 3, comprising:
retrieving the model of the selected article of clothing from a remote machine readable memory accessible over a network connection.

5. The method according to claim 4, comprising:
retrieving the metadata describing the selected article of clothing over the network connection.

6. The method according to claim 4, comprising:
analyzing the model of the selected article of clothing to determine the metadata describing the selected article of clothing.

7. The method according to claim 3, wherein the model of the selected article of clothing is a CAD model, a rendering of the selected article of clothing or generated from a plurality of images of the selected article of clothing.

8. The method according to claim 3, wherein manipulating the model of the selected article of clothing comprises:
resizing the model of the selected article of clothing to correspond to the size of the identified body part of the user.

9. The method according to claim 3, wherein manipulating the model of the selected article of clothing comprises:
rotating the model of the selected article of clothing to match the orientation of the identified body part of the user.

10. The method according to claim 1, comprising:
repeating the method a plurality of times to generate a video of the user having the model of the selected article mapped thereonto.

11. The method according to claim 1, comprising:
inverting the image of the user to create a mirror image.

12. The method according to claim 1, comprising:
scanning the user with a first scanner, the first scanner being arranged to be positioned such that, in use, the user faces both the display and first scanner.

13. The method according to claim 12, comprising:
scanning the user with the first scanner and a second scanner, the second scanner being arranged to take scans concurrently with the first scanner.

14. The method according to claim 13, wherein the first and second scanners are arranged to be positioned such that, in use, they are angularly spaced around the user.

15. The method according to claim 1, wherein at least one image of the user is taken at a same time as the scan, such that the 3D model of the user and the image of the user represent the same point in time.

16. The method according to claim 1, comprising:
receiving a user input to select an article of clothing or to add a selected article to a shopping cart, the user input comprising a gesture made by the user; and
analyzing the 3D model of the user to determine the gesture made and comparing the gesture made to reference data correlating known gestures to different user inputs.

17. A system allowing a user to purchase an article of clothing, the system comprising:
processing circuitry configured to connect with
a camera arranged to take one or more images of the user,
a scanner arranged to determine a location of at least a portion of the user and generate a 3D model of the portion of the user,
a display arranged to display data supplied by the processing circuitry, and
an input mechanism arranged to allow the user to make an input to the processing circuitry;
wherein the processing circuitry is configured to
receive user selection of an article of clothing through the input mechanism,
receive the 3D model of the portion of the user,
identify a body part of the user in the 3D model based on metadata associated with a model of the selected article of clothing,
determine size, location and orientation of the identified body part of the user,
resize, rotate and translate the model of the selected article of clothing to map the selected article on to the 3D model of the portion of the user based on the determined size, location and orientation of the identified body part of the user,
modify the, or each, image of the user to show the portion of the user having the model of the selected article mapped thereonto;
cause the display to display the modified image; and
allow the user to add the selected article of clothing to a shopping cart using the input mechanism.

18. The system of claim 17, wherein the scanner comprises an infrared emitter and an infrared camera, and the processing circuitry is configured to analyze an image taken by the infrared camera to determine where a beam of the infrared emitter reflects from the user.

19. A non-transitory computer-readable medium storing executable computer program code allowing a user to purchase an article of clothing, the program code executable to perform steps comprising:
i) obtaining a three dimensional (3D) model of at least a portion of the user, wherein the 3D model is generated from a scan of a location in which at least the portion of the user is located;
ii) taking one or more images of the user with a camera in proximity to the location;
iii) obtaining user selection of an article of clothing from more than one model of articles of clothing stored in a machine readable memory;
iv) analyzing the 3D model of at least the portion of the user using metadata associated with a model of the selected article of clothing to identify a body part of the user in the 3D model that is associated with the selected article of clothing;
v) determining size, location and orientation of the identified body part of the user,
vi) manipulating the model of the selected article of clothing to map the selected article on the 3D model of the portion of the user based on the determined size, location and orientation of the identified body part of the user;
vii) modifying the, or each, image of the user to show the portion of the user having the model of the selected article mapped thereonto;
viii) causing a display to display the modified image; and
ix) allowing the user to add the selected article to a shopping cart.

20. The non-transitory computer-readable medium of claim 19, wherein the steps comprises:
analyzing the model of the selected article of clothing to determine the metadata describing the selected article of clothing.
